(19) United States
(12) Patent Application Publication
(10) Pub. No.: US 2012/0105468 A1
(43) Pub. Date: May 3, 2012

(54) Display Device And Display Device Driving Method

(75) Inventor: Takashi Sasaki, Osaka (JP)

(73) Assignee: SHARP KABUSHIKI KAISHA, Osaka-shi, Osaka (JP)

(21) Appl. No.: 13/379,891

(22) PCT Filed: Apr. 6, 2010
(86) PCT No.: PCT/JP2010/002521

§ 371 Date: Dec. 21, 2011

(30) Foreign Application Priority Data
Jul. 6, 2009 (JP) 2009-160145

(51) Int. Cl. G09G 5/02; G09G 5/10

(52) U.S. Cl. 345/589; 345/690

(57) ABSTRACT

A display device and a driving method of a display device are each capable of sufficiently removing an image ghost caused in a background during a low gray scale display. In an embodiment, each of the display device and the driving method includes at least one correction device for correcting supplied first image data to second data whose gray scale range has a range which is on a lower brightness gray scale than a lowest brightness gray scale level of the first image data. Thus, each of the display device and the driving method carries out a display in accordance with the second image data obtained by the correction device.

### TECHNICAL FIELD

The present invention relates to a display device in which correction of display data is carried out.

### BACKGROUND ART

According to a liquid crystal display device, a ghost caused during an image display is reduced by carrying out a ghost correction process at a control substrate. Ghost correction is a technique that finds an estimated generation amount of a ghost and carries out digital data correction in accordance with the estimated generation amount of the ghost so as to hide the ghost.

(a) of FIG. 4 shows a normal condition of a display in which a line L1 extending in a horizontal direction is displayed in a background during a black display. In a case where a ghost is caused while the line L1 is being displayed in the background during the black display, such ghost appears as a horizontal streak L2.

The ghost is caused in a case where written display data causes shifts in electric potential of picture elements of adjacent horizontal lines in a display region. The ghost is described as a normal phenomenon in a liquid crystal display panel by Patent Literature 1. Particularly, in a case where same polarities of data signals are written into respective picture elements of a plurality of successive horizontal lines within a same frame, picture element electrodes of a horizontal line which receives corresponding data signals prior to other horizontal lines and thereby becomes floating are (i) rapidly increased in electric potentials by electric potentials at respective picture element electrodes of another horizontal line by which the horizontal line is followed, in a case where display data written into picture elements in the another horizontal line is reversed in polarity from a previous frame so as to be positive, and (ii) rapidly decreased in electric potentials by electric potentials at respective picture element electrodes of such another horizontal line in a case where display data written into picture elements in the another horizontal line is reversed from the previous frame so as to be negative. Thus, an ultimate display condition is reached in which lights whose brightness is different from a target brightness is emitted. A writing order in which the data signals are written into the respective picture elements of the plurality of successive horizontal lines is not limited to an layout order of the plurality of successive horizontal lines. In such a circumstance, the ghost is serious problem to the panel in which a plurality of adjacent horizontal lines are same in polarity, such as frame inversion driving and/or reverse polarity driving in which a plurality of adjacent horizontal lines are same in polarities within a one frame.

In view of the above, the ghost correction has been conventionally carried out as follows. In a case where an image 10 is displayed in a background 101, as shown in Fig. (a) of FIG. 5, a ghost 103 is caused in a background region near the image 102. In this case, the ghost correction process writes display data lower in brightness gray scale than the background 103 into a region where the ghost 103 is caused (i.e., the display data closer to the black display). This causes the region where the ghost 103 is caused to be a region 104 whose gray scale becomes equal to a gray scale for the background so that the ghost is removed, irrespectively of rapid increases or decreases in electrical potentials at picture element electrodes.

### CITATION LIST

### Patent Literatures

Patent Literature 1

Japanese Patent Application Publication, Tokukai, No. 2003-150131 A (Publication Date: May 23, 2003)

Patent Literature 2

Japanese Patent Application Publication, Tokukai, No. 2006-337509 A (Publication Date: Dec. 14, 2006)

### SUMMARY OF INVENTION

### Technical Problem

A conventional ghost correction process can reduce a ghost caused in a background during a mid gray scale display. However, it has almost no effect with respect to ghosts caused in the background during a low gray scale display and a high gray scale display.

For example, in a case where the background 101 shown in (a) of FIG. 5 is an intermediate display, the ghost correction process can write the display data lower in brightness gray scale than the background 101 (i.e., the display data closer to the black display) into the region where the ghost 103 is caused. As such, it is possible to remove the ghost 103 from the region where it is caused. However, in a case where the background 101 is a black display or a low brightness gray scale display close to the black display, as shown in (b) of FIG. 5, it is impossible to write display data sufficiently lower in gray scale than the background 101 into the region where the ghost 103 is caused near the image 102. As such, even the ghost correction process cannot remove the ghost from the region 104.

As understood from the above, a conventional display device has a drawback that an age ghost caused in a background during a low gray scale display cannot be fully removed.

The present invention is made in view of the problem, and an object of the present invention is to provide (i) a display device which can achieve sufficient deletion of an image ghost that appears in a background displayed in a low luminance gray scale and (ii) a display device driving method.

### SOLUTION TO PROBLEM

In order to attain the object, a display device of the present invention includes correction means for correcting supplied first image data to obtain second image data which has a gray scale range which is on a lower brightness gray scale than a lowest gray scale level of the first image data, the display device carrying out a display in accordance with the second image data obtained by the correction means.

According to the invention, it is arranged so that ghost correction is carried out by using the second image data which has the gray scale range which is on the lower brightness gray scale than that gray scale of the first image data which corresponds to a lowest brightness gray scale display (black display). Thus, an image ghost caused in a background during a low brightness gray scale display can be sufficiently removed by writing display data into picture elements of adjacent horizontal lines in accordance with the second image data.

Thus, it is possible to realize the display device capable of sufficiently removing the image ghost caused in the background during the low gray scale display.

In order to attain the object, a driving method of a display device of the present invention includes the steps of: correcting supplied first image data to obtain second image data which has a gray scale range which is on a lower brightness gray scale than a lowest gray scale level of the first image data; and carrying out a display in accordance with the second image data thus obtained.

According to the invention, it is arranged so that ghost correction is carried out by using the second image data having the gray scale range which is on the lower brightness gray scale than that gray scale of the first image data which corresponds to a lowest brightness gray scale display (black display). Thus, an image ghost caused in a background during a low brightness gray scale display can be sufficiently removed by writing display data into picture elements of adjacent horizontal lines in accordance with the second image data.

Thus, it is possible to realize the driving method of a display device which driving method is capable of sufficiently removing the image ghost caused in the background during the low brightness gray scale display.

### ADVANTAGEOUS EFFECTS OF INVENTION

Thus, a display device of the present invention includes correction means for correcting supplied first image data to obtain second image data which has a gray scale range which is on a lower brightness gray scale than a lowest gray scale level of the first image data, the display device carrying out a display in accordance with the second image data obtained by the correction means.

Thus, it is possible to realize the display device capable of sufficiently removing image ghost caused in a background during a low brightness display

### BRIEF DESCRIPTION OF DRAWINGS

FIG. 1

FIG. 1 is a block view showing how correction means and parts around the correction means are configured in accordance with an embodiment of the present invention.

FIG. 2

(a) of FIG. 2 is a graph indicating a relationship between electric potential and gray scale of display data obtained by correction means, in accordance with the embodiment of the present invention. (b) of FIG. 2 is a graph indicating a relationship between electric potential and gray scale of display data, in accordance with a conventional technique.

FIG. 3

FIG. 3 is a block view showing how a display device is configured in accordance with the embodiment of the present invention.

FIG. 4

(a) of FIG. 4 is a view showing a condition in which no ghost is caused, in accordance with a conventional technique. (b) of FIG. 4 is a view showing a condition in which a ghost is caused, in accordance with the conventional technique.

FIG. 5

(a) of FIG. 5 is a view showing how a ghost caused in a background during, an intermediate gray scale display is corrected, in accordance with a conventional technique. (b) of FIG. 5 is a view showing how a ghost caused in a background during a low gray scale display is corrected, in accordance with the conventional technique.

### DESCRIPTION OF EMBODIMENTS

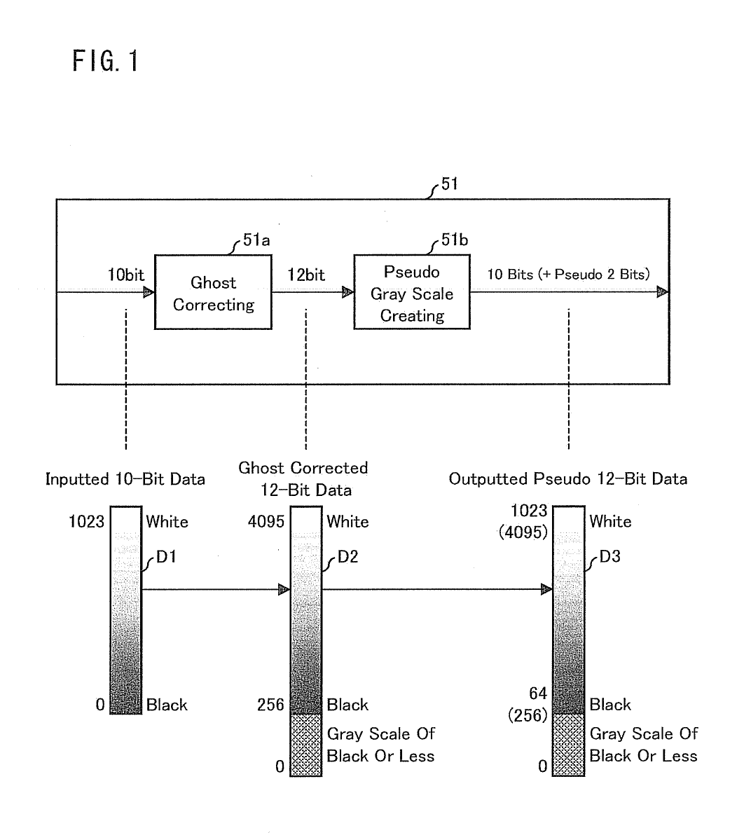

One embodiment of the present invention is described below with reference to FIGS. 1 through 3.

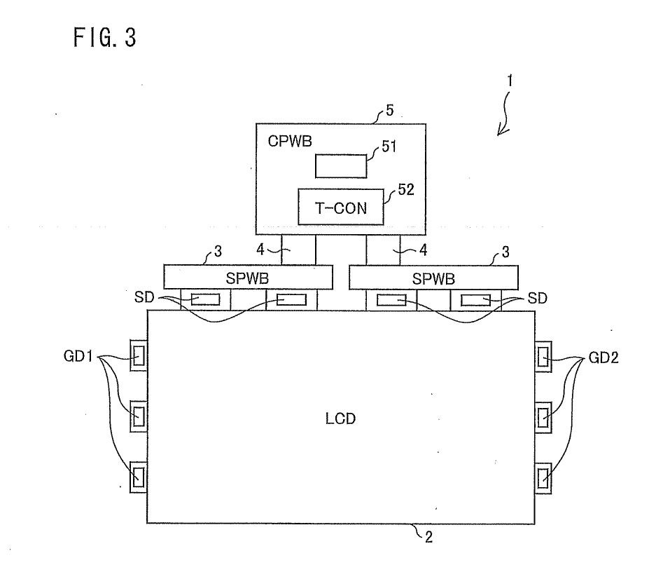

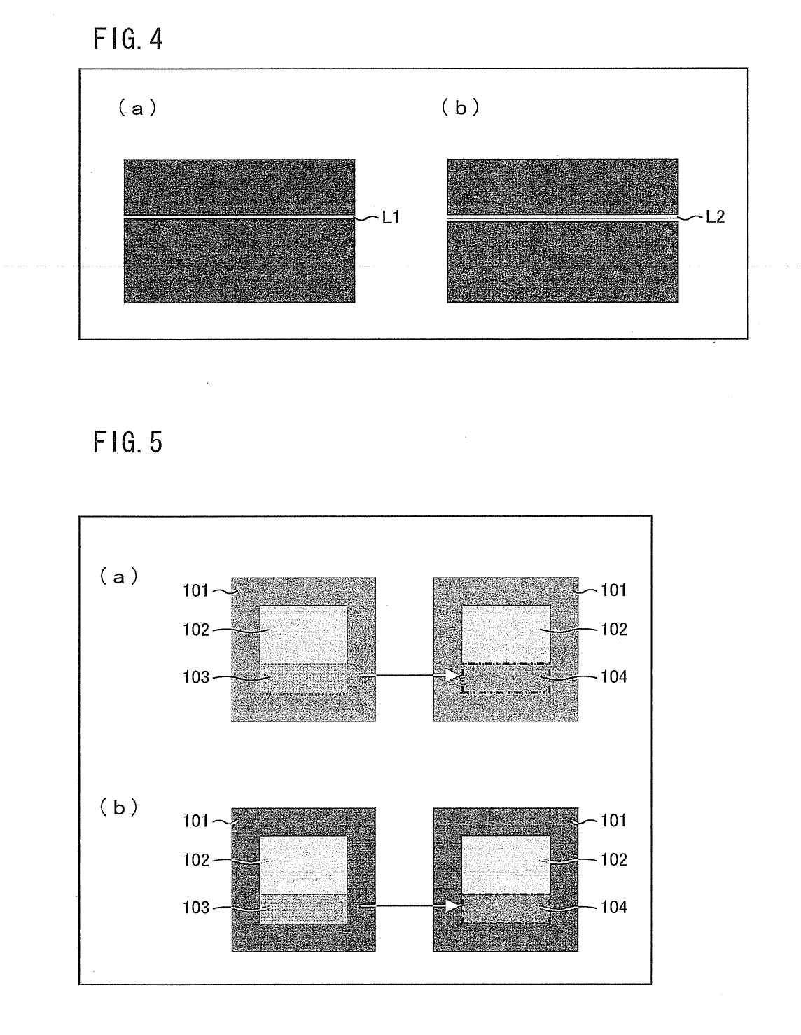

FIG. 3 shows how a liquid crystal display device (display device) 1 is configured in accordance with the present embodiment. As shown in FIG. 3, the liquid crystal display device 1 includes a display panel 2, source printed wiring boards (SPWB) 3, a plurality of source drivers (display drivers) SD . . . , a plurality of gate drivers GD1 . . . and GD2 . . . , flexible lines 4, and a display control substrate (CPWB) 5. Note that any combination of the display panel 2 and the other constituents of the liquid crystal display device 1 can be provided on a single substrate. This can be substituted with a configuration in which (i) an external substrate, such as a flexible printed wiring board, on which some or all of (a) the plurality of source drivers SD . . . , (b) the plurality of gate drivers GD1 . . . and GD2 . . . , and (c) the display control substrate 5 are provided and (ii) a panel in which the display panel 2 is provided are connected with each other. The present embodiment is thus not limited to a specific layout and configuration.

The display panel 2 is a panel in which picture elements each having any configuration are provided in a matrix manner. Note that it is assumed that the display panel 2 is of a so called multi picture element type in which each pixel is made up of two sub picture elements, for example. A polarity of a data signal written into each picture element is reversed every frame, and polarities of data signals are reversed so that the data signals having identical polarities are consecutively written, in each frame, into picture elements in a plurality of lines. According to the multi picture element panel, it does not matter whether writing operations are carried out with respect to the respective plurality of lines belonging to each block during respective consecutive horizontal periods. This is because, in a case where the each block is assumed to contain the picture elements of the plurality of consecutive horizontal lines, it is not always true that the writing operations are carried out with respect to the respective plurality of lines belonging to the each block during the respective consecutive horizontal periods. What matters is that, after a writing operation is carried out with respect to picture elements in a preceding one of the plurality of lines, a writing operation is carried out with respect to a subsequent one of the plurality of lines.

The plurality of source drivers SD . . . and the plurality of gate drivers GD1 . . . and GD2 . . . are connected with the display panel 2 by use of SOF (System On Film). According to the present embodiment, the plurality of source drivers SD . . . are merely connected with a first side of the display panel 2, whereas the gate drivers GD1 . . . and the gate drivers GD2 . . . are respectively connected with second and third sides of the display panel 2. The first side extends in a direction orthogonal to each of the second and third sides. However, the present embodiment is not limited to this. The plurality of source drivers SD . . . are also connected with the source printed wiring boards 3 so as to receive sets of display data from the source printed wiring boards 3. The source printed wiring boards 3 are connected with the display control substrate 5 via the flexible lines 4. The display control substrate 5 includes a data processing section 51 and a timing controller. 52. The display control substrate 5 supplies timing signals which are used by the plurality of source drivers SD . . . and the plurality of gate drivers GD1 . . . and GD2 . . . , sets of display data which are used by the plurality of source drivers SD . . . , and storage capacitor voltages which are used by a CS mainline group. The timing signals that are used by the plurality of gate drivers GD1 . . . and GD2 . . . and the storage capacitor voltages that are used by the CS mainline group are supplied to the display panel 2, via the source printed wiring boards 3 and the SOF of the plurality of source drivers SD . . . .

FIG. 1 shows how the data processing section 51 is configured. Note that the data processing section 51 is configured by ASIC, a memory, and the like, for example. The data processing section 51 includes a ghost correction processing section (correction means) 51a and a pseudo gray scale creation section (image data conversion means) 51b. The data processing section 51 can further include LVDS (Low Voltage Differential Signaling) receiver/driver, a cross-talk correction section, a gamma correction section, an overshoot process section, a feed-through voltage correction section, a timing control section for polarity reverse driving, and the like.

The ghost correction processing section 51a carries out a ghost correction to supplied first image data D1 (e.g., 10-bit image data), and then outputs the second image data D2 (e.g., 12-bit image data) that has been subjected to the ghost correction. In this case, the first image data D1 has a gray scale level falling within a range of 0 to 1023. 0 gray scale side is assumed to correspond to a lower brightness gray scale side (i.e., a black display side). The second image data D2 has a gray scale falling within a range of 0 to 4095, of which a gray scale range from 256 to 4095 is allocated in a case where a ghost correction can be carried out within a gray scale range which is used in a normal image display. A gray scale range from 0 to 255 of the second image data D2 is allocated in a case where image data, on a lower brightness gray scale side than a black display level, is necessary in order to fully remove ghost by the ghost correction. As such, in a case where a background is displayed so as to have a low brightness gray scale around 0 gray scale which corresponds to the black display level (i.e., a lowest gray scale level) of the first image data D1, a gray scale is selected from 0 to 255, which is a lower brightness gray scale than the black display, as a gray scale of the second image data D2 which is written to remove the ghost by the ghost correction. During the ghost correction, a lookup table is referred to find appropriate second image data D2, stored in the lookup table, which corresponds to the first image data D1, for example.

The pseudo gray scale creation section 51b converts, into third image data D3 which can be used in display driving by the plurality of source drivers SD . . . , the second image data D2 supplied from the ghost correction processing section 51a. Thereafter, the pseudo gray scale creation section 51b outputs the third image data D3. In this case, of a gray scale range of 0 to 1023 shown by 12-bit data created by adding pseudo 2-bit data to the first image data, a gray scale range of 64 to 1023 is used as a gray scale range of a normal display, whereas a gray scale range from 0 to 64 is used as a gray scale range of image data which (i) has a lower brightness gray scale than the black display level and (ii) is used in the ghost correction. The third image data D3 is created, in accordance with a gray scale level of the second image data D2, by so called frame rate control. According to the frame rate control, (i) the number of frames is increased by switching a frame at a frequency of higher than an original frame frequency and then (ii) a gray scale dl is allotted to F1 frames of a plurality of F frames thus increased and a gray scale d2 is allotted to F2 frames of the F frames, the F frames being made up of the F1 frames and the F2 frames. This allows a pseudo intermediate gray scale between the gray scales d1 and d2 to be displayed. In this case, F=4, for example. The third image data D3 is reconfigured as mapping data in which contributions of a luminance are shared by surrounding pixels around a target pixel with the use of dithering or ordered dithering during a period of the plurality of F frames. Thereafter, the third image data D3 thus reconfigured is outputted.

Note that none of the first image data D1, the second image data D2, and the third image data D3 is limited to the above bit number. Bit numbers of respective of the first image data D1, the second image data D2, and the third image data D3 can be any bit numbers. Further, the third image data D3 is not limited to a specific configuration. In a case where the image data D2 is suitable for direct use in display driving, the third image data is not necessary.

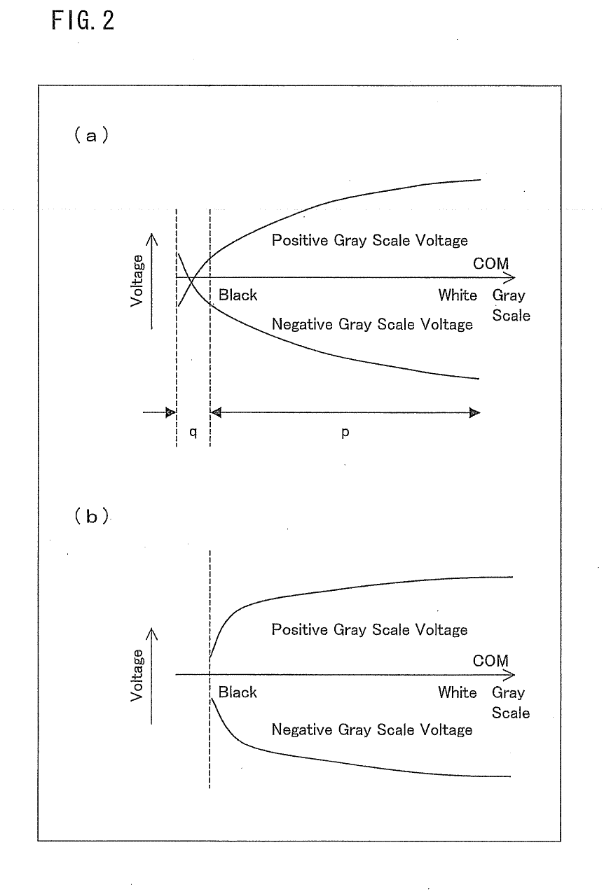

(a) of FIG. 2 shows a relationship between (i) the gray scale range of the second image data used in the present embodiment and (ii) a voltage range of the display data written into the picture element.

As shown in (a) of FIG. 2, a gray scale range of the second image data D2 is made up of (i) a gray scale range p from a black display to a white display and (ii) a gray scale range q which is on a lower brightness gray scale side than the black display. Thus, the gray scale range of the gray scale of the second image data D2 is wider, by the gray scale range q, than a conventional gray scale range shown in (b) of FIG. 2. In the gray scale range q, a voltage, which is applied to liquid crystal and is equal to a difference between the electric potential of the display data and a common electric potential COM, is smaller than a voltage which is applied to liquid crystal so as to carry out the black display. In the gray scale range q, the electric potential of the display data can be smaller than the common electric potential COM in a case where a positive data signal is written, and can be greater than the common electric potential COM in a case where a negative data signal is written (seen (a) of FIG. 2).

According to the display device of the present invention, the ghost correction is made by securing the gray scale range which is on the lower brightness gray scale side than the gray scale used in the lowest brightness gray scale display (i.e., black display) of the first image data D1. As such, an image ghost, appeared in a background which is displayed so as to have the low brightness gray scale, can be fully removed by writing the display data into picture elements of adjacent horizontal lines in accordance with the second image data.

Note that, according to the frame rate control, the gray scale range q can be provided by combining existing electric potentials such as an electric potential of black display data on a positive polarity side, the common electric potential COM, and an electric potential of the black display data on a negative polarity side. As such, it is not necessary to extend a range of a power supply voltage, in order to realize the electric potential range of the display data shown in (a) of FIG. 2. In a case where an analog gray scale reference voltage, prepared for each gray scale level, is supplied to a panel from the plurality of source drivers SD . . . , an electric potential, which is more approximate to the common electric potential than the electric potential of the black display in the gray scale range q, can be used as a power supply voltage.

Note also that the gray scale range p of the second image data D2 does not necessarily have a highest brightness gray scale level identical with a highest brightness gray scale level of the first image data D1. It is possible to satisfactorily correct the ghost, which (i) has not been conventionally corrected and (ii) is appeared in the background that is displayed so as to have the low brightness gray scale display, provided that the lowest brightness gray scale level (i.e., the black display level) in the gray scale range p of the second image data D2 is identical with a lowest brightness gray scale level of the first image data D1. Note, however, that, in a case where the gray scale range p of the second image data D2 has the highest brightness gray scale level identical with the highest brightness gray scale level of the first image data D1, a gray scale range used in a normal image display of the first image data D1 becomes identical with that of the second image data D2. As such, it is possible to satisfactorily carry out the ghost correction while securing an intended reproducible range of an image display.

In order to attain the object, a display device of the present invention includes correction means for correcting supplied first image data to obtain second image data which has a gray scale range which is on a lower brightness gray scale than a lowest gray scale level of the first image data, the display device carrying out a display in accordance with the second image data obtained by the correction means.

According to the invention, it is arranged such that ghost correction is carried out by using the second image data having the gray scale range which is on the lower brightness gray scale than that gray scale of the first image data which corresponds to a lowest brightness gray scale display (black display). Thus, image ghost caused in a background during a low brightness gray scale can be sufficiently removed by writing display data into picture elements of adjacent horizontal lines in accordance with the second image data.

Thus, it is possible to realize a display device capable of sufficiently removing an image ghost caused in a background during a low brightness gray scale display.

In order to attain the object, the display device of the present invention is configured so that the gray scale range of the second image data has a highest brightness gray scale level identical with a highest brightness gray scale level of the first image data.

According to the invention, the gray scale ranges of the first image data and the second image data have same ranges for a normal image display. This brings about an effect of securing an original reproducible range of an image display and suitably carrying out ghost correction.

In order to attain the object, the display device of the present invention is configured so as to carry out the display by using a gray scale reference voltage corresponding to a gray scale level of the second image data obtained by the correction means.

According to the invention, it is possible, in the display device that carries out the display by using an analog gray scale reference voltage, to carry out good ghost correction.

In order to attain the object, the display device of the present invention further includes image data conversion means for converting the second image data, obtained by the correction means, into third image data by frame rate control.

According to the invention, it is possible to realize, by simply combining existing electric potentials, a range of an electric potential of display data corresponding to the gray scale which is on the lower brightness gray scale than the lowest brightness gray scale level of the first image data. As such, it is not necessary to extend a range of a power supply voltage.

In order to attain the object, the display device of the present invention is configured so that a polarity of a data signal written into each picture element is reversed every frame, and polarities of data signals are reversed so that the data signals having identical polarities are consecutively written, in each frame, into picture elements in a plurality of consecutive lines.

According to the present invention, it is possible to suitably correct ghost caused in the display device whose picture elements are driven by polarity reverse driving in which polarities of data signals written into picture elements of a plurality of adjacent lines are reversed.

In order to attain the object, a driving method of a display device includes the steps of: correcting supplied first image data to obtain second image data which has a gray scale range which is on a lower brightness gray scale than a lowest gray scale level of the first image data; and carrying out a display in accordance with the second image data thus obtained.

According to the invention, ghost correction is carried out by using the second image data which has the gray scale range which is on a lower the brightness gray scale than that gray scale of the first image data which corresponds to a lowest brightness gray scale display (black display). Thus, an image ghost caused in a background during the low brightness gray scale display can be sufficiently removed by writing display data into picture elements of adjacent horizontal lines in accordance with the second image data.

Thus, it is possible to realize the driving method of a display device which driving method is capable of sufficiently removing the image ghost caused in the background during the low gray scale display.

In order to attain the object, the driving method of the invention is arranged so that the gray scale range of the second image data has a highest brightness gray scale level identical with a highest brightness gray scale level of the first image data.

According to the invention, the gray scale ranges of the first image data and the second image data have same gray scale range for a normal image display. This brings about an effect of securing an original reproducible range of an image display and suitably carrying out the ghost correction.

In order to attain the object, the driving method of the present invention is arranged so that a display is carried out by using a gray scale reference voltage corresponding to a gray scale level of the second image data thus obtained.

According to the invention, it is possible, in the display device that carries out a display by using an analog gray scale reference voltage, to suitably carry out the ghost correction.

In order to attain the object, the driving method of the present invention is arranged so that the second image data is converted into third image data by frame rate control.

According to the invention, it is possible to realize, by simply combining existing electric potentials, a range of an electric potential of display data corresponding to the gray scale range which is on the lower brightness gray scale than the lowest brightness gray scale level of the first image data. As such, it is not necessary to extend a range of a power supply voltage.

The present invention is not limited to the embodiments above, but may be altered by a skilled person within the scope of the claims. That is, an embodiment based on a proper combination of technical means altered as appropriate within the scope of the claims is encompassed in the technical scope of the present invention.

### Industrial Applicability

The present invention can be suitably used to a liquid crystal television device or the like.

Reference Signs List
1: liquid crystal display device (display device)
51a: ghost correction processing section (correction means)
51b: pseudo gray scale creation section (image data conversion means)
D1: first image data
D2: second image data
D3: third image data

1. A display device, comprising
correction means for correcting supplied first image data to obtain second image data which has a gray scale range which is on a lower brightness gray scale than a lowest gray scale level of the first image data,
the display device carrying out a display in accordance with the second image data obtained by the correction means.

2. The display device as set forth in claim 1, wherein:
the gray scale range of the second image data has a highest brightness gray scale level identical with a highest brightness gray scale level of the first image data.

3. The display device as set forth in claim 1, which carries out the display by using a gray scale reference voltage corresponding to a gray scale level of the second image data obtained by the correction means.

4. The display device as set forth in claim 1, further comprising
image data conversion means for converting the second image data, obtained by the correction means, into third image data by frame rate control.

5. The display device as set forth in claim 1, wherein:
a polarity of a data signal written into each picture element is reversed every frame, and polarities of data signals are reversed so that the data signals having identical polarities are consecutively written, in each frame, into picture elements in a plurality of consecutive lines.

6. A driving method of a display device, comprising the steps of:
correcting supplied first image data to obtain second image data which has a gray scale range which is on a lower brightness gray scale than a lowest gray scale level of the first image data; and
carrying out a display in accordance with the second image data thus obtained.

7. The driving method as set forth in claim 6, wherein:
the gray scale range of the second image data has a highest brightness gray scale level identical with a highest brightness gray scale level of the first image data.

8. The driving method as set forth in claim 6, wherein:
a display is carried out by using a gray scale reference voltage corresponding to a gray scale level of the second image data thus obtained.

9. The driving method as set forth in claim 6, wherein:
the second image data is converted into third image data by frame rate control.
